(19) United States
(12) Patent Application Publication
(10) Pub. No.: US 2017/0112096 A1
(43) Pub. Date: Apr. 27, 2017

(54) FUSION OF DOG APPAREL AND DOG FOOTWEAR VIA ASSEMBLIES

(71) Applicant: ANGELA HELENE GRAVES, MAYHILL, NM (US)

(72) Inventor: ANGELA HELENE GRAVES, MAYHILL, NM (US)

(21) Appl. No.: 14/922,689

(22) Filed: Oct. 26, 2015

(51) Int. Cl. A01K 13/00; A01K 29/00

(52) U.S. Cl. CPC A01K 13/007; A01K 29/00

(57) ABSTRACT

Mankind has long been using dog apparel and dog footwear to shield dogs when they go outside during cold and wet weather. One of the difficulties with that solution is the complete outfit sometimes fails to remain on the dog for the entire outing. Especially easy to fall off is the footwear. The present invention fuses dog apparel and dog footwear together all in one. The joining of apparel and footwear revolves around two virtually identical assemblies made of tubular fabric and springy material strips. Tubular fabric is attached around the top of each item of footwear and is also attached to the top of the apparel above both the front and back legs along the spine. Springy material strips are inserted and threaded through the tubular fabric thereby joining the apparel and footwear together.

### BACKGROUND OF THE INVENTION

The field of the invention is protective dog apparel and dog footwear.

Partially because mankind domesticated the wild wolf and proceeded to transplant their descendents to far away geographical locations and climates, some dogs are perhaps more vulnerable to their environment than they should be.

Man typically shares his home with his dog, thus requiring man to take his pet outside to enable the dog to relieve himself and exercise. Unfortunately the weather is not always suitable for outdoor activities. Due to man's fondness for his pet, he embraces his responsibility of keeping his dog warm and dry so therefore he dresses his dog in dog apparel and dog footwear. Even though the human caregiver takes his duty of shielding his dog from frostbite and hypothermia very seriously, the dog however, is often uncooperative. Therein lays the rub; how to protect a beloved pet that is not always a willing participant in his own well being.

Here are four examples of prior art from the many previous inventions that have the purpose of keeping dogs safe in cold climatic conditions: 1) A patent that has a single purpose of footwear, U.S. Pat. No. 5,495,828, Soloman et al., 1996, ANIMAL BOOTS WITH DETACHABLE, VERTICALLY ADJUSTABLE FASTENING STRAP. 2) A patent that has a single purpose of apparel, U.S. Pat. No. 6,584,939B1, Bresinski, 2003, ANIMAL COAT. 3) A patent that has a dual purpose of both footwear and apparel and features separable pieces, U.S. Pat. No. 6,024,055, Jesse, Sr. et al., 2000, DOG SWEATER WITH INTEGRAL LEGS. 4) A patent that has a dual purpose of both a suspender system designed to prevent footwear from slipping off of the dog's paws and is detachable from the footwear plus is adjustable and also includes a set of bootees is, U.S. Pat. No. 4,744,333, Taylor, 1988, PROTECTIVE FOOTWEAR FOR ANIMALS.

Prior art, however, has not yet achieved a virtually hassle free joining of dog apparel and dog footwear that can simultaneously protect a dog's body and paws without multiple articles of gear, fasteners, adjusters, and removable parts. Another shortcoming of prior art is the gear shifting during wear. To qualify further, protective apparel and especially protective footwear that are easy to put on a dog, and yet remain on the dog reliably is definitely lacking success and a better option is needed.

### BRIEF SUMMARY OF THE INVENTION

Societal norms as well as laws often dictate the safeguarding of domesticated animals and our pets are usually given an even higher level of care. The present invention pertains to using dog apparel and dog footwear to shield dogs when they go outside during cold and wet weather. The main object of the invention is dog footwear that will remain on the dog's paws reliably. The invention's uniquely designed assembly has solved that long standing issue with dog footwear by fusing the dog apparel and dog footwear together all in one.

The second object of the invention is footwear that can be put on a dog easily instead of the task turning into an extended time consuming battle that stresses both the owner and his dog. The invention's footwear simply slips on the dog's paws. The third object of the invention is to reduce the anxiety of a dog who must be dressed in footwear. The invention's footwear, although slightly padded, is still thin enough for the dog to be able to detect the ground beneath him, which makes him feel more stable and in control. The fourth object of the invention is usability. The invention's custom sizing eliminates the need for adjustable hardware. In addition, the slip on style saves pet owners from the hassle of fasteners like buckles that are difficult for arthritic hands to release, zippers that catch fur or get stuck, and loop and hook closures that fail over time as they gunk up with debris. Also the preparation time needed for outdoor activities is reduced since multiple layers of separate gear are no longer necessary. The fifth object of the invention is to provide protection from inclement weather to a dog's body and paws simultaneously. The invention's assembly allows for dog apparel and dog footwear to marry together. The sixth object of the invention is an ideal selection of construction materials to complete the object of protection. Materials that offer waterproofing, wind blocking, body heat retention even in damp conditions and also puncture resistant, slip resistant and impervious to oil and grease paw coverings are necessary. Wool, foamed neoprene laminated with fabric and neoprene coated nylon achieve these requirements of the invention. The seventh object of the invention is to give the opportunity for freedom of movement. Bulky and cumbersome dog apparel and dog footwear can hinder a dog's activity. The invention's fabric and materials result in light in weight but heavy in protection dog apparel and dog footwear.

The invention's apparel is fashioned in a style of a pull over the head garment. It consists of two layers, a bottom layer and a top layer. The bottom layer is shaped similar to a tank top shirt and is made of foamed neoprene laminated with fabric and bonded with wool felt. It consists of two pieces assembled together; a chest/belly piece and a back/spine piece. The chest/belly piece is shaped similar to a capital letter “Y”. The top layer is attached to the bottom layer along the spine and is shaped similar to a rain poncho coat and is made of a thinner foamed neoprene laminated with fabric. It consists of only one piece and has a leash attachment ring affixed to it.

The invention's footwear is fashioned in a style of a slip on sock or bootie. Each bootie is made of a single piece of foamed neoprene laminated with fabric thus only has one seam down one side and around the toes. A protective covering made out of neoprene coated nylon and consisting of two pieces caps over the toes and also provides a pad for the bottom of the bootie.

What makes the invention unique from all others is the joining of apparel and footwear that revolves around an assembly made of tubular fabric and springy material strips. Tubular fabric is wrapped around the top of each item of footwear and is fixedly attached, leaving an exit/entrance gap for the springy material strip. In addition, tubular fabric is also fixedly attached to the apparel perpendicular to the spine above both the front and back legs. A springy material strip is then inserted and threaded through the tubular fabric making a closed loop in the front, and another one in the back, thereby joining the footwear and apparel together. Lastly, the second attached top layer of the apparel drapes protectively over the assemblies lessoning the possibility of potential entanglements with foreign objects.

### BRIEF DESCRIPTION OF DRAWINGS

FIG. 1 shows an exploded plan top view of the invention.

FIG. 2 shows a dog wearing the invention.

### DETAILED DESCRIPTION OF THE INVENTION

The present invention is to be used for the purpose of keeping dogs warmer and drier than if the dogs were undressed while outside in inclement weather. The invention is several pieces combined to form a single unit and slips on the dog not unlike many other dog clothes and dog shoes, except the invention is particularly easy to get on the dog. The invention consists of three sections: assemblies, dog footwear and dog apparel. The dog apparel and dog footwear might be considered to be an old or obvious component of the invention and because of that they are not listed in the claims. Therefore, the focus is given to the assemblies, which is the only section out of the three that is claimed. Slight deviations in the future of the dog apparel and dog footwear of the present invention have no affect on the validity of my claim for the assemblies.

The assemblies section consists of the assembly device that unites the apparel to the footwear and is made of tubular fabric and springy material strips. Preferred embodiments for the assembly device utilize tubular webbing for the tubular fabric and woven elastic for the springy material strips. The footwear section is made of neoprene and consists of a single pattern piece for each of the two front footwear items and the back two footwear items. The bottom of each of the four footwear items is capped in puncture resistant and slip resistant neoprene coated nylon. The apparel section consists of a bottom layer and a top layer. The bottom layer is made of neoprene and wool bonded together and consists of two pattern pieces and approximates a shirt. The top layer is made of neoprene and consists of one pattern piece and approximates a coat and has a leash attachment ring. The bottom layer and the top layer are fixedly attached together.

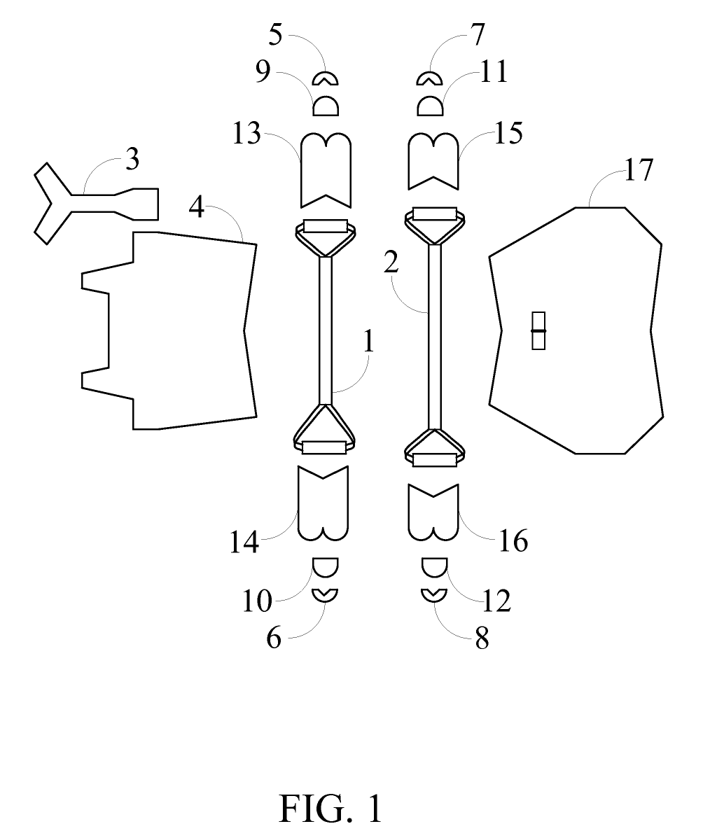

FIG. 1 illustrates the three sections of the present invention in an exploded top view: assemblies, dog footwear and dog apparel. The front assembly 1 and the back assembly 2 are what are claimed in the present invention. They consist of tubular fabric with springy material strips threaded through. The bottom layer of the apparel consists of two pieces, the chest/belly piece 3 and the back/spine piece 4. The two pieces permanently connect on both sides of the neck, and both sides of the chest. The protective toe coverings: 5, 6, 7, 8 and the slip resistant pads: 9, 10, 11, 12 are permanently connected to each other. The front assembly 1 permanently connects to the front right footwear 13 and the front left footwear 14. The back assembly 2 permanently connects to the back right footwear 15 and the back left footwear 16. Once all footwear have been attached to the assemblies, they are folded in half to form the bootie shape and inserted into the protective caps Both the front assembly 1 and the back assembly 2 permanently connect to the bottom layer apparel 4. The bottom layer apparel item 4 is permanently connected to the top layer apparel 17 which has a D-ring attached to it.

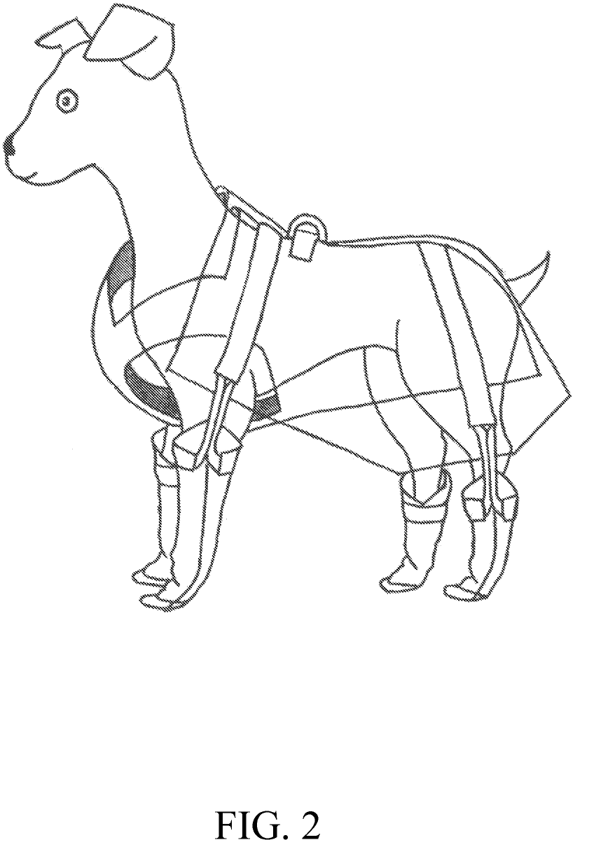

FIG. 2 illustrates a dog wearing the invention. The apparel is depicted as if it was constructed of a transparent material for the reason of allowing the assemblies to be shown and is for display purposes only. The oversize neck hole and two front leg holes convey how it is possible to slip the loose fitting garment onto the dog without any adjusting hardware.

The exact lengths and widths of fabric and material required vary with the sizing requirements of each individual dog. Currently the intent is custom sizing based on each dog, but could be scaled up for larger production by actually defining a sizing system based on the most popular sizes sold. Currently the intent is hand made, but machine assistance might become preferred in the future.

For instruction purposes, the following are guidelines for the preferred embodiments of the present invention. There is required jumping back and forth between sections, because even though they are separate, they all attach to each other.

The assembly section materials preferred are: polyester tubular webbing, satin woven elastic, seam sealing tape for neoprene fabrics (iron on), and bonded polyester thread. The assembly steps are: Cut the webbing into four equal sections for each of the four booties. Cut the webbing into sections for the front and the back of the apparel. Typically the back webbing section will be longer than the front section because the front footwear are usually taller than the back footwear. With a small crafting iron, iron on seam tape near the edges of the cut tubular webbing to prevent fraying. Also iron on the seam tape to the middle of the tubular webbing sections intended for the apparel, because this is for additional strength when you sew them onto the apparel. You will iron on in two places, one on each side of the spine, with approximately half of one inch spacing in between them. Set aside until the four footwear booties are cut out and seam tape is ironed on the top edges of the booties as per the footwear section. Hand stitch the tubular webbing to the top of one of the booties by running a stitch near the top and also near the bottom of the webbing taking care to add a few extra stitches for strength on the ends, yet leaving the tubular webbing open for the elastic to be threaded through. Thread the scrap elastic through the webbing while still flat, as a place holder. (Later you will tie your elastic to the scrap and pull though. Repeat with remaining three booties. Return to the footwear section to continue the booties. Set aside until the apparel bottom layer of foamed neoprene and wool felt have been bonded together and cut into the patterns consisting of a back/spine piece and a chest/belly piece as per the apparel section. Hand stitch both the tubular webbing sections to the back of the back/spine piece. This entails sewing the front webbing to the front of the apparel and the back webbing to the back of the apparel. You must sew on top of the seam tape sections for strength. To clarify, the stitches are along the spine, and the ends of the tubular webbing dangle down freely. Insert a scrap section of wire as a placeholder into both the front and back webbing sections so that can be used to hook and pull through the elastic later. Return to the apparel section to continue the apparel. Set aside until all steps have been completed in both the footwear section and the apparel section. The last thing to do to complete the assembly is thread the elastic through. Start with one front bootie by tying the elastic to the pre-threaded scrap elastic in the bootie tubular webbing and pull through. Once through, cut off the scrap. Then catch both ends of the elastic with the pre-threaded wire in the apparel tubular webbing at the front of the apparel and pull though. Take one of the ends and tie to the scrap elastic on the opposite sided front bootie and pull through. Cut your elastic on your pre marked length and throw away the excess and then secure the two loose ends of the elastic with stitches followed by ironing on seam tape for reinforcement. Repeat with the back footwear booties and the back of apparel.

The footwear section materials preferred are: 2 mm foamed neoprene laminated with fabric, neoprene coated nylon, ¾″ wide seam sealing tape for neoprene fabrics (iron on), bonded polyester thread, tube of contact cement for neoprene. The footwear steps are: Cut out both the bootie patterns for the front paws and bootie patterns for the back paws out of foamed neoprene. The front booties are usually taller than the back booties. The outer portion of the bootie that is also the seam wherein both sides are sewn together rises up to form an upside down “v” to protect the dog's leg from the woven elastic. The inner portion of the bootie is shaped like a “v” to prevent the underside of the dog from being rubbed and irritated. Iron two small sections of seam tape folded over the top edges of four footwear items with a small crafting iron. Add a really small piece of heat tape in the inner corner of each for a finishing touch. Return to the assembly section to continue the assembly device. Fold in half to form a bootie and then hand stitch with thread a blanket stitch all the way around the cut edge. Iron on seam tape over the edges, covering the stitches; one longer piece along the straight edge, and shorter pieces (approximately three to five small pieces as needed) around the curve, overlap a little and trim off the excess. Add a really small piece of heat tape to the top corner edge as a finishing touch. Repeat with remaining three booties. Cut out cap two piece pattern out of the neoprene coated nylon. The top piece covers the paw's toes, and the bottom piece provides a slip resistant surface for the bootie. Lay the top and bottom pieces over each other and iron on seam tape on the curved surface only. Because the seam tape is straight, this will required several small overlapping pieces to fit around the curve, and you will need to trim off some excess. Let cool. Because the sides are open and free, it is possible to now flip the cap inside out. When you look at the curved portion you can see the seam tape's underside. Slip the neoprene bootie inside the neoprene coated nylon cap. To secure the cap to the bootie, iron on a piece of seam tape across the bottom of the bootie that is half on the neoprene and half on the neoprene coated nylon. You repeat this on the top of the bootie, but before you do, cut a notch out of the seam tape that mirrors the shape of the cap. Finish securing the cap by ironing on seam tape along the sides. Trim off excess as it approaches the curve. Using the tube of cement, run a bead of cement along the curved part around the toes, just extending up far enough to obtain the waterproofing desired. Let dry and then apply a second coat of cement. Repeat with remaining three booties. Return to the assembly section to complete the invention.

The apparel section materials preferred are: 3 mm foamed neoprene laminated with fabric, 3 mm wool felt, bonding, adhesive sheet (iron on), 2 mm foamed neoprene laminated with fabric, 1″ wide polyester tubular webbing, ¾″ wide seam sealing tape for neoprene fabrics (iron on), bonded polyester thread, 1″ stainless steel powder coated D-ring. The apparel steps are: With a high wattage hot iron, iron on the bonding adhesive to fuse the 3 mm foamed neoprene to the 3 mm wool felt. Cut out the bottom layer patterns which consist of a back/spine piece and a chest/belly piece. Return to the assembly section to continue the assembly device. Iron on seam tape to all edges of the bottom layer pieces that will not be sewn together. Hand sew with a blanket stitch the two pieces (back/spine and chest/belly) together. They come together at the top of the neck hole on each side and at the sides of the belly. Iron on seam tape over all the stitching. Iron on small pieces of seam tape around miscellaneous odd corners for a finishing touch. Next is the top layer of apparel, which is made of 2 mm foamed neoprene. The main function is to drape over the assembly to protect it. Cut out the single piece pattern. Iron seam tape around all edges with any small finishing touches on outer corners as needed. Iron on seam tape near the edges of the piece of tubular webbing to prevent fraying. Take the piece of tubular webbing and loop the D-ring into it and fixedly attach with stitches on the upper-middle portion of the apparel. The exact location is directly below the front assembly webbing. Sew along all edges, as well as an “X” pattern in the center to secure. Lay the two layers of apparel on top of each other and line up. The top layer overlaps the bottom layer because it is larger. Before you begin sewing, flip over to the wool and iron on some seam tape for your stitches to go through. (This is because the wool felt fibers are perhaps not the most strong of an anchor considering all the stress that the garment is going to be under when the dog pulls.) Using that same tubular webbing piece that attaches the D-ring, stitch all the way through both layers, to connect them together. Return back to the assembly section to complete the invention.

The present invention is a union of dog apparel and dog footwear via two virtually identical assemblies. While the focus is on the joining of dog apparel and dog footwear, for convenience a leash attachment ring to tether the dog is also included. The main object of fusing dog apparel and dog footwear together is to facilitate footwear that remains on the dogs paws more reliably. It is the way that the two separate items of apparel and footwear are united that is unique.

Dog apparel and dog footwear were invented a long time ago and over the years there have been many improvements and modifications as well as many different intended purposes. The device that is the assembly in the present invention is new, novel and non-obvious, yet the dog apparel and dog footwear are necessary to complete the present invention. The assembly device by itself would not accomplish keeping the dog warm and dry, which is the purpose of the present invention, but the assembly is the aspect that provides the solution to the problem of dog footwear falling off of the dog. A dog cannot remain warm and dry on an inclement weather day if the footwear that his owner placed on him is lost somewhere outside possibly in a blanket of snow.

To meet all seven of the present inventions objects, some styles of dog apparel and dog footwear are going to work better than others. Thus, the present inventions dog apparel and dog footwear are designs optimized for the particular purposes of this present invention. Even though the exact patterns of the dog apparel and dog footwear resemble a rain poncho, a tank top, and socks, they are still of my own making, and not a direct replica of any prior art. The claim of the invention is an assembly that is used twice; once with the front footwear and a second time repeated with the back footwear. These two assemblies are what connect the dog apparel to the dog footwear.

I claim:

1. Two separate and virtually identical assemblies, one used to join the two front dog footwear items to the front of the dog apparel item and also another one duplicated again to join the two back dog footwear items to the back of the dog apparel item. Each assembly is comprised of two smaller sections of tubular fabric and one larger section of tubular fabric, and a springy material strip. The springy material strip is inserted and is threaded through the larger section of tubular fabric, then threaded through the first smaller section of tubular fabric, then back through the larger section of tubular fabric in the opposite direction, then threaded through the second smaller section of tubular fabric, then both ends of the springy material strips are fixedly attached to each other thus forming a closed loop.
a. Each assembly is fixedly attached to a left sided dog footwear item and also repeated on a right sided dog footwear item per the small sections of tubular fabric.
b. Each assembly is fixedly attached to the same item of dog apparel; the first at the front of the garment and the second at the back of the garment per the larger section of tubular fabric of each assembly.
